(19) United States
(12) Patent Application Publication
(10) Pub. No.: US 2016/0201555 A1
(43) Pub. Date: Jul. 14, 2016

(54) HEAT SHIELD FILM AND METHOD OF FORMING HEAT SHIELD FILM

(71) Applicant: TOYOTA JIDOSHA KABUSHIKI KAISHA, Toyota-shi, Aichi-ken (JP)

(72) Inventor: Akinori EDA, Nagakute-shi, Aichi-ken (JP)

(73) Assignee: TOYOTA JIDOSHA KABUSHIKI KAISHA, Toyota-shi, Aichi-ken (JP)

(21) Appl. No.: 14/912,261

(22) PCT Filed: Aug. 18, 2014
(86) PCT No.: PCT/IB2014/001549

§ 371 Date: Feb. 16, 2016

(30) Foreign Application Priority Data
Aug. 22, 2013 (JP) 2013-172139

(51) Int. Cl. F02B 77/11; B22D 21/00; C23D 5/02; B22D 19/08

(52) U.S. Cl. CPC F02B 77/11; B22D 19/08; B22D 21/007; C23D 5/02

(57) ABSTRACT

A heat shield film (100) that is formed on a wall surface of an aluminum-based member (W) includes: a matrix layer (10) diffusion-bonded to the wall surface (diffusion bonding layer (10′)), having a coefficient of linear expansion of 15×10⁻⁶/K to 25×10⁻⁶/K in a temperature range of ordinary temperature to 200° C. and made of a porcelain enamel material; and hollow particles (20) dispersed in the matrix layer (10).

### BACKGROUND OF THE INVENTION

1. Field of the Invention

The invention relates to a heat shield film that is formed on a wall surface of an aluminum-based member and a method of forming the heat shield film, and, for example, relates to a heat shield film that is formed on part or all of a wall surface facing a combustion chamber of an internal combustion engine and a method of forming the heat shield film.

2. Description of Related Art

An internal combustion engine, such as a gasoline engine and a diesel engine, is mainly formed of an engine block, a cylinder head and a piston. A combustion chamber of the internal combustion engine is defined by a bore face of the cylinder block, a top face of the piston assembled in the bore, a bottom face of the cylinder head and top faces of intake and exhaust valves arranged in the cylinder head. With high-power requirements to recent internal combustion engines, it is important to reduce the cooling losses of the internal combustion engines. As one of measures to reduce the cooling losses, there is a method of forming a heat shield film made of ceramics on an inner wall of the combustion chamber.

However, because the above-described ceramics generally have a low thermal conductivity and a high thermal capacity, there occurs a decrease in intake efficiency or knocking (abnormal combustion due to remaining of heat in the combustion chamber) due to a steady increase in surface temperature. Therefore, the ceramics have not presently become widespread as a film material for the inner wall of the combustion chamber.

For this reason, the heat shield film that is formed on the wall surface of the combustion chamber is desirably formed of a material having not only heat-resistant property and heat insulation property as a matter of course but also a low thermal conductivity and a low thermal capacity. Furthermore, in addition to the low thermal conductivity and low thermal capacity, the film desirably has a deformability so as to be able to follow explosion pressure at the time of combustion in the combustion chamber, injection pressure, and repetition of thermal expansion and thermal shrinkage, and is desirably hard to cause, interfacial peeling due to a thermal deformation amount between the film and a matrix of a cylinderblock, or the like.

Focusing on an existing known technique, Japanese Patent Application Publication No. 2009-243355 (JP 2009-243355 A) and Japanese Patent Application Publication No. 2010-185291 (JP 2010-185291 A) each describe an internal combustion engine that includes a heat insulation thin film in which bubbles are formed inside a material having a thermal conductivity lower than that of a matrix forming a combustion chamber of the internal combustion engine and having a thermal capacity lower than or equal to that of the matrix.

In this way, JP 2009-243355 A and JP 2010-185291 A each describe a technique for forming a film having a low thermal conductivity and a low thermal capacity on an inner wall of the combustion chamber of the internal combustion engine, and the film can be a heat insulation film (heat shield film) having excellent capabilities as described above.

However, these heat insulation film structures are such that bubbles are formed inside a heat insulation material made of ceramics, or the like, so a high deformability is not expected from the heat insulation film. Therefore, there can be an inconvenience that the heat insulation film is damaged because of thermal fatigue in process of receiving repeated stress of thermal expansion and thermal shrinkage in the combustion chamber, a thermal deformation difference is easy to increase between the heat insulation film and a base material made of an aluminum matrix, and peeling is easy to occur at the interface between the heat insulation film and the base material.

### SUMMARY OF THE INVENTION

The invention provides a heat shield film having a low thermal conductivity, a low thermal capacity and a deformability of being able to follow repetition of thermal expansion and thermal shrinkage, and hard to cause interfacial peeling due to a thermal deformation difference between the heat shield film and a wall surface formed of an aluminum-based member, such as a cylinder block, and a method of forming the heat shield film on the wall surface.

A first aspect of the invention provides a heat shield film. The heat shield film includes: a matrix layer having a coefficient of linear expansion of 15×10⁻⁶/K to 25×10⁻⁶/K in a temperature range of ordinary temperature to 200° C. and made of a porcelain enamel material; and hollow particles dispersed in the matrix layer, wherein the heat shield film is formed on a wall surface of an aluminum-based member, and the heat shield film is diffusion-bonded to the wall surface.

A member of the wall surface on which the heat shield film according to the first aspect of the invention is formed is made of aluminum or an alloy of aluminum. The application of the wall surface may be not only a wall surface facing a combustion chamber of an internal combustion engine (in this case, the member is a piston, a cylinder head, or the like, that constitutes the combustion chamber, and the wall surface is a top face of the piston or a bottom face of the cylinder head), but also wall surfaces of various applications that require a low thermal conductivity and a low thermal capacity, such as a wall surface that constitutes an intake/exhaust line of a vehicle, a wall surface that constitutes a turbine blade, and an exterior wall of an internal combustion engine, a house or a housing that accommodates a space shuttle, or the like. When the heat shield film is applied to the internal combustion engine, the internal combustion engine may be intended for any one of a gasoline engine and a diesel engine.

In the heat shield film according to the first aspect of the invention, the porcelain enamel material is applied to the matrix layer, and, more specifically, the porcelain enamel material has a coefficient of linear expansion of 15×10⁻⁶/K to 25×10⁻⁶/K in a temperature range of ordinary temperature to 200° C. In addition, the hollow particles are dispersed in the matrix layer, and the heat shield film is formed of the matrix layer and the hollow particles. The heat shield film is diffusion-bonded to the wall surface of the aluminum-based member. The “ordinary temperature” means a temperature of about 15 to 25° C.

In this way, because the heat shield film is diffusion-bonded to the wall surface of the aluminum-based member, the bonding strength of the interface therebetween increases. Because the heat shield film is formed of the porcelain enamel material having a coefficient of linear expansion of 15×10⁻⁶/K to 25×10⁻⁶/K in a temperature range of ordinary temperature to 200° C., the coefficient of linear expansion is substantially equal to a coefficient of linear expansion of the aluminum-based member (depending on the type of alloy, a coefficient of linear expansion of 19×10⁻⁶/K to 23×10⁻⁶/K). Thus, almost no thermal deformation difference occurs therebetween. In this way, because the bonding strength between the heat shield film and the wall surface of the aluminum-based member is high due to diffusion bonding and there is almost no thermal deformation difference between the heat shield film and the member, the effect of preventing interfacial peeling increases.

Through verification of the inventors, it is determined that the mixed material of a vanadium-based glass frit and a glaze is suitable as the material of the porcelain enamel material that constitutes the heat shield film formed on the aluminum-based wall surface.

In the heat shield film according to the first aspect of the invention, a glass transition temperature of the porcelain enamel material may be lower than or equal to 400° C., and a heat-resistant temperature of the porcelain enamel material may be higher than or equal to 450° C. The swing effect of the heat shield film will be described.

A heat loss Q (W) in the cylinder of the internal combustion engine may be expressed by (Mathematical Expression 1) Q=A×h×(Tg−Twall) by using a heat transfer coefficient h (W/(m²K)) due to the pressure and gas flow in the cylinder, a surface area A (m²) in the cylinder, a gas temperature Tg(K) in the cylinder and a temperature Twall(K) of the wall surface facing the inside of the cylinder. In cycles of the internal combustion engine, the in-cylinder gas temperature Tg changes momentarily. By momentarily changing the wall surface temperature Twall such that the wall surface temperature Twall follows the in-cylinder gas temperature Tg, it is possible to reduce the value of (Tg−Twall) in the mathematical expression 1, so it is possible to reduce the heat loss Q.

A variation in the combustion chamber wall surface temperature Twall may be referred to as swing width, and the trackability of the combustion chamber wall surface temperature to the gas temperature in the cylinder may be referred to as swing characteristic, swing effect, or the like. A temperature difference between the wall temperature and the cylinder gas temperature reduces when the temperature trackability is high, so it is possible to reduce heat loss, and it is possible to improve fuel economy. As the swing width increases, the effect of improving fuel economy increases, so the thermophysical property of the heat shield film is required to have a low thermal conductivity and a low volumetric specific heat in order to increase the swing width.

In connection with the swing effect of the heat shield film, there occurs a temperature gradient based on the swing width (250 to 500° C.) within the heat shield film. In a heat shield film made of a ceramics material having a large Young's modulus (for example, the Young's modulus of alumina is 360 GPa) as in the case of the existing heat shield film, stress in the heat shield film increases, and there is a possibility that an in-film fracture occurs.

250° C. may be prescribed as a threshold (target value) regarding the swing width indicating fuel economy performance. For example, when the swing width is 250° C., 250° C. is a temperature difference (or a temperature gradient) between the wall surface and the surface of the heat shield film. Because the temperature of the wall surface increase to about 200° C. at the time of engine start, the surface temperature of the heat shield film is expressed by 200+250=450° C. where the temperature of the wall surface is 200° C. By employing the porcelain enamel material such that the surface temperature of the heat shield film is lower than or equal to 450° C., more desirably, the porcelain enamel material having 400° C. lower by 50° C. than 450° C. as a glass transition point, the heat shield film is easy to become soft at the time when the engine is heated, and it is possible to suppress a fracture in the film, such as occurrence of a crack in the film of the heat shield film at the time when the engine is heated. That is, temperature stress can occur on the inner or outer surface of the heat shield film due to the temperature gradient of 250° C.; however, a fracture in the film due to the temperature stress is suppressed because the heat shield film has become soft.

On the other hand, it is desirable that the surface of the heat shield film does not thermally alter in the temperature atmosphere of 450° C. (heat-resistant property). Through verification of the inventors, it is determined that the heat shield film having a glass transition temperature lower than or equal to 400° C. and a heat-resistant property of about 450° C. or higher by employing the heat shield film made of the above-described vanadium-based porcelain enamel material.

In the heat shield film according to the first aspect of the invention, the porcelain enamel material may contain silica, each of the hollow particles may have a silica-based outer shell, and a surface of each silica-based outer shell may be modified with a hydrophilic group.

At the time of forming the heat shield film, the glass frit is mixed with the glaze, a material obtained by causing the mixture to contain the hollow particles and adjusting the viscosity with water is, for example, sprayed to the wall surface, and the porcelain enamel material is fired by heating. Thus, the heat shield film is formed. When the vanadium-based glass frit (vanadium oxide) is employed as the material of the porcelain enamel material, in the case where the glass frit is formed of a mixed material of the vanadium oxide and silica or in the case where silica is contained in the glaze, each of the hollow particles has a silica-based outer shell, and has a high adhesion to the porcelain enamel material. In addition, a hydrophilic group modifies the surface of each hollow particle, so the hollow particles are allowed to be uniformly dispersed in water at the time when the porcelain enamel material and the hollow particles are mixed with water. As a result, it is possible to uniformly disperse the hollow particles in the heat shield film to be formed. A carboxyl group may be employed as the “hydrophilic group”.

In the heat shield film according to the first aspect of the invention, the heat shield film may have a two-layer structure of an upper layer and a base layer adjacent to the wall surface, and the base layer may contain no hollow particles or may contain the hollow particles in an amount smaller than that of the upper layer.

The heat shield film has a two-layer structure formed of the upper layer and the base layer adjacent to the wall surface, and the base layer contains no hollow particles or contains the hollow particles in an amount smaller than that of the upper layer, so the following advantageous effect is expected. It is required to contain a large amount of the hollow particles as much as possible in order to achieve the function of the heat shield film, and it is known that the thickness of the heat shield film needs to be set to about 100 μm and the average content of the hollow particles in the two layers needs to be set to about 3.5 percent by mass as one configuration for achieving, for example, 250° C. swing width. For example, each of the upper layer and the base layer may have a thickness of 50 μm and only the upper layer may contain the hollow particles of 7 percent by mass of all (3.5 percent by mass as the average of the overall heat shield film).

The first advantageous effect is that the base layer has a lower firing temperature than the upper layer, so the glass frit of the base layer melts in advance to start flowing at the time when the temperature is increased during firing. For example, the firing temperature of a layer containing no hollow particles is about 550° C., whereas the firing temperature of a layer containing 5 to 10 percent by mass of the hollow particles is about 630° C. This is because heat is drawn by the hollow particles and the firing temperature increases when the hollow particles are contained. At the time when the base layer starts flowing, the viscosity of the base layer is low because the base layer contains no hollow particles or contains a smaller amount of the hollow particles than that of the upper layer, so the base layer is, for example, able to enter any fine gaps, such as a crack formed in the upper layer. As a result, it is possible to form the heat shield film with no crack.

The second advantageous effect is that, because the base layer contain no hollow particles or contains a small amount of the hollow particles, the base layer has a coefficient of linear expansion of 16×10⁻⁶/K that is the coefficient of linear expansion of the porcelain enamel material itself or a coefficient of linear expansion close to this, so the magnitude relation in coefficient of linear expansion among the wall surface of the aluminum-based member, the base layer and the upper layer is expressed by Member>Base layer>Upper layer, and a difference in coefficient of linear expansion is relieved (gradient effect). With this advantageous effect, it is possible to reduce interfacial stress that occurs because of a temperature difference at the time of, for example, a temperature change from firing at about 630° C. to ordinary temperature, so it is possible to prevent a crack.

A second aspect of the invention provides a method of forming a heat shield film. The method includes: a first step of manufacturing an intermediate product formed of an aluminum-based plate and a heat shield film on a surface of the plate by applying a mixed material of hollow particles, a glass frit and a glaze onto the surface of the plate; melting the glass frit by heating, and forming the heat shield film, formed of a matrix layer and the hollow particles dispersed in the matrix layer, on the surface of the plate, the matrix layer having a coefficient of linear expansion of 15×10⁻⁶/K to 25×10⁻⁶/K in a temperature range of ordinary temperature to 200° C. and made of a porcelain enamel material; and a second step of forming the heat shield film on a wall surface of an aluminum-based member formed of a molten metal hardened portion and the plate integrated with the hardened portion by accommodating the intermediate product in a die and casting aluminum-based molten metal on the plate of the intermediate product.

When the heat shield film made of the porcelain enamel material is deposited on a member, such as an engine head, there is a method in which a mixed material of the hollow particles, a glass frit and a glaze is applied to a machined product and is then fired by heating; however, because the deposition temperature is high and about 650° C., there is a concern about the influence on a product through heating the entire product. There is a method in which the heat shield film made of the porcelain enamel material is formed in casting step before machining; however, as a result of verification of the inventors, it is found that large bubbles are generated in the heat shield film, causing a reduction in film strength. This is because gas is generated from the material of the porcelain enamel material when molten metal is poured into the die; however, generated gas has no room to escape because the film is surrounded by the molten metal and the die, and the generated gas stays inside the film to form large bubbles.

Therefore, in the method according to the second aspect of the invention, the intermediate product in which the heat shield film is formed on the surface of the aluminum-based plate is manufactured by applying a mixed material of the hollow particles, a glass frit and a glaze onto the surface of the plate having a desired shape and melting the glass frit by heating, the intermediate product is set in the die, and then molten metal is poured.

Part of the plate of the intermediate product melts by heat of the molten metal, the melted part and the molten metal hardens to be integrated with each other to form the aluminum-based member. The heat shield film has been already formed on one face of the member, so large bubbles are not generated in the heat shield film.

In the method of forming a heat shield film, the thickness of the plate may range from 1 mm to 2 mm.

When the thickness of the plate is too thin, the plate may be broken by heat of molten metal. It is found through verification of the inventors that there is a risk of breakage when the thickness of the plate is smaller than 1 mm.

On the other hand, the amount of molten metal that is poured into the die is limited to a certain amount in terms of a solidification time of the molten metal. That is, because a solidification time is determined, there occurs a portion that is not sufficiently solidified when a large amount of molten metal is poured, and the quality of the hardened portion is impaired. When the thickness of the plate becomes thick, heat at the time when molten metal contacts the plate escapes over the entire plate, so it is not possible to sufficiently melt the surface of the plate. Even when the thickness of the plate is thick but the amount of molten metal is large, it is possible to sufficiently melt the surface of the plate. However, as described above, because the amount of molten metal is limited to a certain amount or below, it is not possible to sufficiently melt the surface of the excessively thick plate. In this way, when the amount of molten metal that is poured into the die is limited and the surface of the plate is not sufficiently melted in the case where the thickness of the plate is too thick, there is a concern that a gap is formed between the surface of the plate and the hardened portion formed by integrating molten metal due to the fact that the surface of the plate is not sufficiently melted in the case where the thickness of the plate is excessively thick. According to verification of the inventors, it is found that there is such a risk in the range in which the thickness of the plate exceeds 2 mm.

According to the above-described verification results, by forming the heat shield film on the wall surface with the use of the intermediate product in which the heat shield film is formed in advance on the surface of the plate having a thickness of the range of 1 mm to 2 mm, it is possible to manufacture an aluminum product (engine, or the like) including the heat shield film having a high interfacial strength without forming large bubbles at the interface between the heat shield film and the wall surface.

As can be understood from the above description, with the heat shield film according to the first aspect of the invention, the heat shield film, formed of the matrix layer made of the porcelain enamel material having a coefficient of linear expansion close to the coefficient of linear expansion of aluminum and the hollow particles dispersed in the matrix layer, is formed on the wall surface of the aluminum-based member, so the heat shield film has a low thermal conductivity, a low volumetric specific heat and a high effect of improving interfacial peeling between the member and the heat shield film. With the method of forming a heat shield film according to the second aspect of the invention, no bubbles are generated in the heat shield film or at the interface between the heat shield film and the member, so it is possible to form the heat shield film having a high film strength and a high interfacial strength.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a longitudinal cross-sectional view that shows a first embodiment of the heat shield film according to the invention together with an aluminum-based member;

FIG. 2 is a graph that illustrates a swing width;

FIG. 3 is a longitudinal cross-sectional view that shows a second embodiment of the heat shield film according to the invention together with an aluminum-based member;

FIG. 4 is a flowchart that illustrates a first step of the method of forming a heat shield film according to the invention;

FIG. 5 is a flowchart that illustrates a second step of the method of forming a heat shield film according to the invention;

FIG. 6 is a view that illustrates a heat shield film formed by the method of forming a heat shield film according to the invention;

FIG. 7 is a longitudinal cross-sectional view that shows an example in which the heat shield film according to the invention is applied to a wall surface facing a combustion chamber of an internal combustion engine;

FIG. 8 is a graph that shows the correlation between a shearing stress at the interface between a heat shield film and an aluminum-based member and a stress inside the heat shield film for a heat shield film made of an aluminum-based porcelain enamel material, a heat shield film made of an alumina and a heat shield film made of an alumite;

FIG. 9 is a graph that shows the measured result of the thermophysical property of a heat shield film according to Example;

FIG. 10 is a view that shows the SEM photograph of the interface between the heat shield film according to Example and an aluminum-based member, and the EPMA line analysis result;

FIG. 11 is a view that illustrates Example of the method of forming a heat shield film;

FIG. 12 is an experimental result by which the effectiveness of Example of the method of forming a heat shield film has been examined, and is a cross-sectional photograph by which it is determined whether there is a bubble inside the heat shield film;

FIG. 13 is an experimental result by which the effectiveness of Example of the method of forming a heat shield has been examined, and is a plan photograph by which it is determined whether there is a crack on the surface of the heat shield film; and

FIG. 14 is a view that shows an experimental result by which an optimal range of the thickness of a plate is determined.

### DETAILED DESCRIPTION OF EMBODIMENTS

Hereinafter, embodiments of a heat shield film and a method of forming a heat shield film according to the invention will be described with reference to the accompanying drawings. Although Example in which the illustrated heat shield film is applied is a wall surface facing a combustion chamber of an internal combustion engine, the application of a wall surface to which the heat shield film is applied may be not only the wall surface facing a combustion chamber but also wall surfaces of various applications that require a low thermal conductivity and a low thermal capacity, such as a wall surface that constitutes an intake/exhaust line of a vehicle, a wall surface that constitutes a turbine blade, and an exterior wall of an internal combustion engine, a house and a housing that accommodates a space shuttle, or the like.

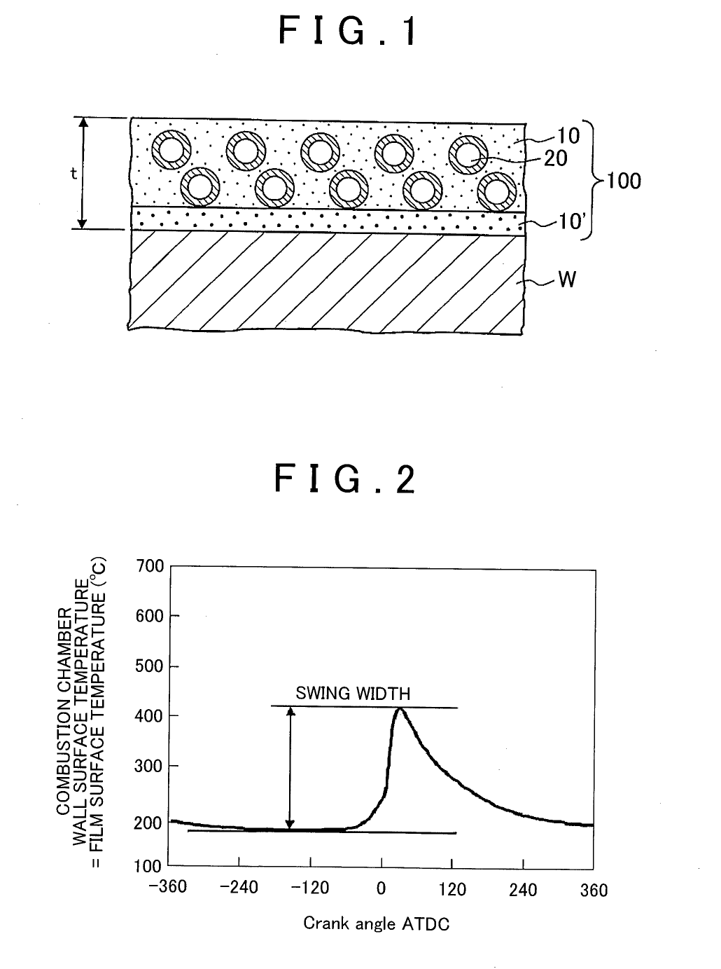

FIG. 1 is a longitudinal cross-sectional view that shows a first embodiment of the heat shield film. An illustrated heat shield film 100 is formed of a matrix layer 10 made of a porcelain enamel material and hollow particles 20 dispersed inside the matrix layer 10. Part of the matrix layer 10 constitutes a diffusion bonding layer 10′, and is formed on a wall surface of an aluminum-based member W. The thickness t of the heat shield film 100 is about 100 μm.

Because the heat shield film 100 is formed on the wall surface of the aluminum-based member W, a raw material compatible with the aluminum-based member W is employed as the porcelain enamel material forming the matrix layer 10.

The porcelain enamel material is formed of a material mixing a vanadium-based glass frit with a glaze. The heat shield film 100 has a coefficient of linear expansion of 15×10⁻⁶/K to 25×10⁻⁶/K in a temperature range of ordinary temperature to 200° C., and has a coefficient of linear expansion substantially equal to that of the aluminum-based member W (depending on the type of alloy, a coefficient of linear expansion of 19×10⁻⁶/K to 23×10⁻⁶/K). Thus, almost no thermal deformation difference occurs between the heat shield film 100 and the aluminum-based member W.

In this way, because of the fact that the heat shield film 100 is bonded to the member W via the diffusion bonding layer 10′ and the fact that there is no large difference in coefficient of linear expansion between the heat shield film 100 and the member W and, therefore, almost no thermal deformation difference occurs therebetween, a fracture or peeling at the interface between the heat shield film 100 and the member W is, suppressed.

At the time when the heat shield film 100 is formed, vanadium-based (vanadium oxide) glass frit (containing silica) is mixed with a glaze (containing titanium oxide and silica), a material obtained by causing the mixture to contain the hollow particles 20 and adjusting the viscosity with water is sprayed to the wall surface, the glass frit is melted by firing the material through heating, and is then hardened. Thus, the heat shield film 100 in which the hollow particles are dispersed inside the matrix layer 10 is formed.

Each of the hollow particles 20 has a silica-based outer shell, and has a high adhesion to the porcelain enamel material containing silica. In addition, a hydrophilic group (carboxyl group) modifies the surface of each hollow particle 20, so the hollow particles 20 are allowed to be uniformly dispersed in water at the time when the porcelain enamel material and the hollow particles 20 are mixed with water. Thus, it is possible to form the heat shield film 100 in which the hollow particles 20 are uniformly dispersed inside the matrix layer 10.

In addition, the glass transition temperature of the porcelain enamel material that forms the matrix layer 10 is lower than or equal to 400° C., and the heat-resistant temperature of the porcelain enamel material is higher than or equal to 450° C.

The swing width will be schematically described with reference to the conceptual view of the swing width shown in FIG. 2. By changing a wall surface temperature of the combustion chamber such that the wall surface temperature follows a cylinder gas temperature, a temperature difference between the wall temperature and the cylinder gas temperature is reduced, so fuel economy is improved as a result of a reduction in heat loss. The width of variation in the wall surface temperature of the combustion chamber is defined as swing width. As the swing width increases, the effect of improving fuel economy increases. To increase the swing width, the thermophysical property of the heat shield film needs to be a low thermal conductivity and a low volumetric specific heat.

A threshold (target value) of the heat shield film 100 regarding the swing width indicating fuel economy performance may be prescribed as 250° C. The swing width 250° C. becomes a temperature difference or a temperature gradient between the wall surface of the member W and the surface (surface across from, the interface) of the heat shield film 100. The temperature of the wall surface generally increases to about 200° C. at the time of engine start, so the surface temperature of the heat shield film 100 is 200+250=450° C. where the temperature of the wall surface is 200° C. By employing the porcelain enamel material such that the surface temperature of the heat shield film 100 is lower than or equal to 450° C., more desirably, the porcelain enamel material having 400° C. lower by 50° C. than 450° C. as a glass transition point, the heat shield film 100 is easy to become soft at the time when the engine is heated, and it is possible to suppress a fracture in the film, such as occurrence of a crack in the film of the heat shield film 100 at the time when the engine is heated. That is, temperature stress can occur on the inner or outer surface of the heat shield film 100 due to the temperature gradient of 250° C.; however, a fracture in the film due to the temperature stress is suppressed because the heat shield film 100 has become soft.

The heat shield film 100 made of the vanadium-based porcelain enamel material has been identified through examination of the inventors that the surface of the heat shield film does not thermally alter in a temperature atmosphere of 450° C. (heat-resistant property). Thus, the heat shield film 100 has a heat-resistant property at the time when the surface temperature of the heat shield film 100 is 450° C.

In this way, the illustrated heat shield film 100 suppresses an interfacial fracture or interfacial peeling at the interface with the wall surface of the aluminum-based member W, suppresses a fracture in the heat shield film 100, and has a heat-resistant property in a high-temperature atmosphere during engine operation.

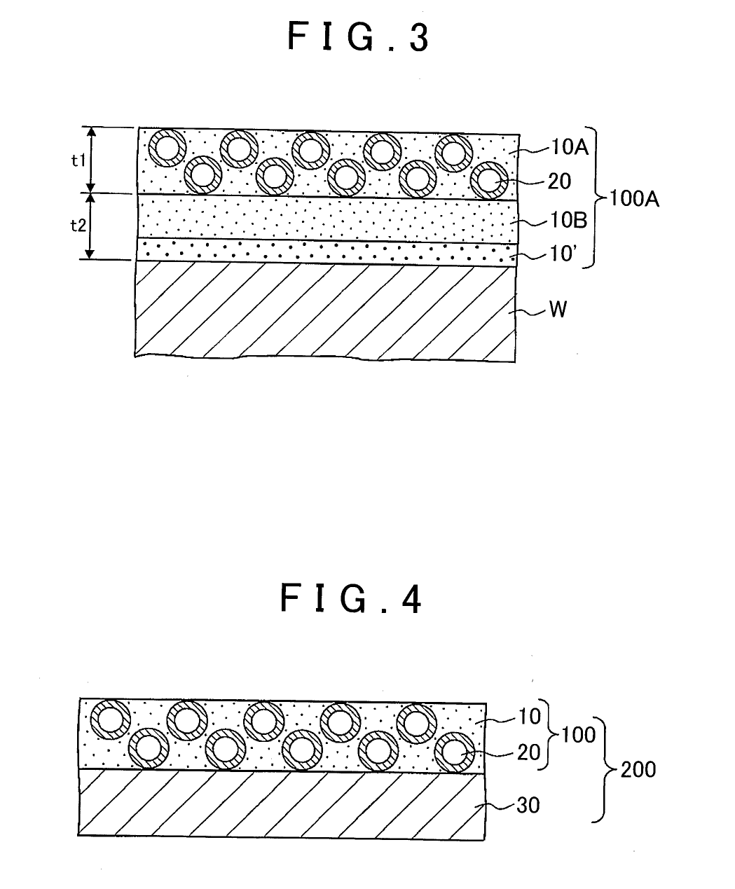

FIG. 3 is a longitudinal cross-sectional view that shows a second embodiment of the heat shield film. An illustrated heat shield film 100A has a two-layer structure formed of an upper layer 10A and a base layer 10B adjacent to the wall surface of the member W (the diffusion bonding layer 10′ is included in the base layer 10B). The base layer 10B contains no hollow particles. Only the upper layer 10A contains the hollow particles 20. Each of the thickness t1 of the upper layer 10A and the thickness t2 of the base layer 10B is about 50 μm. In another embodiment, the base layer also contains the hollow particles, but the content of the hollow particles in the upper layer is relatively large.

The heat shield film 100A has a two-layer structure formed of the upper layer 10A and the base layer 10B adjacent to the wall surface, and the base layer 10B contains no hollow particles. Therefore, the base layer 10B has a lower firing temperature than the upper layer 10A, so the glass frit of the base layer 10B melts in advance to start flowing at the time when the temperature is increased during firing. For example, the firing temperature of a layer containing no hollow particles 20 is about 550° C., whereas the firing temperature of a layer containing 5 to 10 percent by mass of the hollow particles 20 is about 630° C. This is because heat is drawn by the hollow particles 20 and the firing temperature increases when the hollow particles 20 are contained. At the time when the base layer 10B starts flowing, the viscosity of the base layer 10B is low because the base layer 10B contains no hollow particles 20, so the base layer 10B is, for example, able to enter any fine gaps, such as a crack formed in the upper layer 10A. As a result, it is possible to form the heat shield film 100A with no crack. The second advantageous effect is that, because the base layer 10B contains no hollow particles 20, the base layer 10B has a coefficient of linear expansion of 16×10⁻⁶/K that is the coefficient of linear expansion of the porcelain enamel material itself, so the magnitude relation in coefficient of linear expansion among the wall surface of the aluminum-based member W, the base layer 10B and the upper layer 10A is expressed by Member W>Base layer 10B>Upper layer 10A, and a difference in coefficient of linear expansion is relieved (gradient effect). With this advantageous effect, it is possible to reduce interfacial stress that occurs because of a temperature difference at the time of for example, a temperature change from firing at about 630° C. to ordinary temperature, so it is possible to prevent a crack.

In the above-described first embodiment of the heat shield film, a general method of forming a heat shield film is schematically described. A method of forming a heat shield film, in which the forming method itself is characteristic, will be described. That is, the forming method is able to eliminate an inconvenience that, at the time when a heat shield film made of a porcelain enamel material is formed in a casting step before machining, large bubbles are generated in the heat shield film, causing a decrease in film strength.

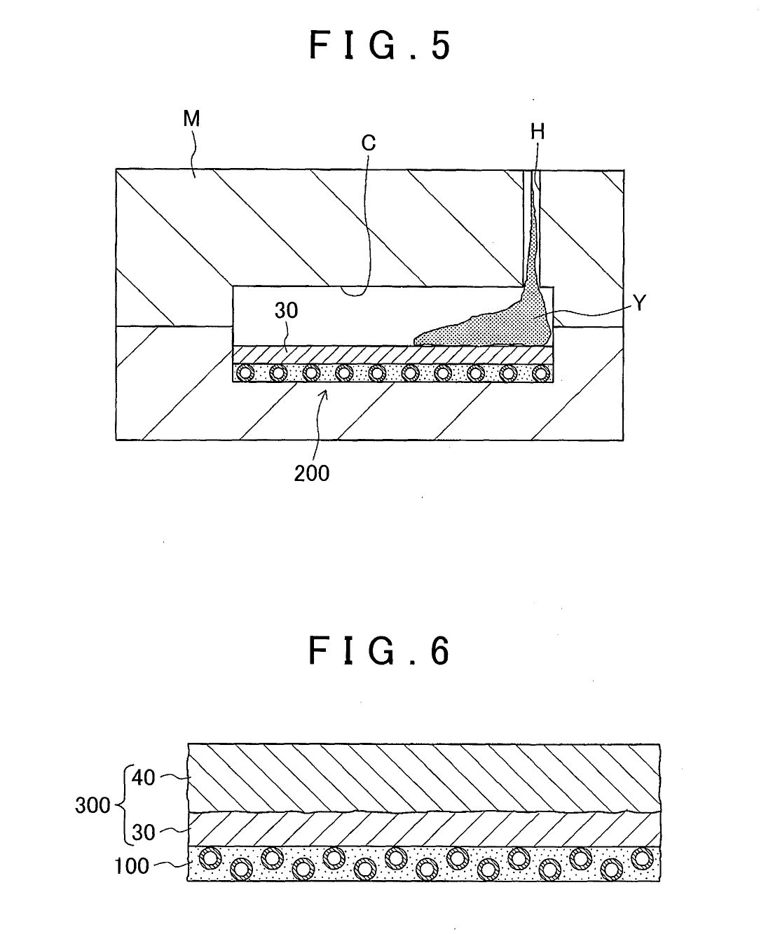

FIG. 4 to FIG. 6 show a flowchart of a method of forming a heat shield film in this order. More specifically, FIG. 4 is a view that illustrates a first step of the forming method. FIG. 5 is a view that illustrates a second step of the forming method. FIG. 6 is a view that shows a heat shield film formed by the forming method.

Initially, as shown in FIG. 4, a mixed material of the hollow particles 20, a glass frit and a glaze is applied to the surface of an aluminum-based plate 30, the glass frit is melted by heating, and the heat shield film 100, formed of the matrix layer 10 and the hollow particles 20 dispersed in the matrix layer 10, is formed on the surface of the plate 30. The matrix layer 10 has a coefficient of linear expansion of 15×10⁻⁶/K to 25×10⁻⁶/K in the temperature range of ordinary temperature to 200° C. and is made of the porcelain enamel material. Thus, an intermediate product 200 formed of the plate 30 and the heat shield film 100 on the surface of the plate 30 is manufactured (first step).

Subsequently, as shown in FIG. 5, the intermediate product 200 is accommodated in a cavity C of a molding die M such that the plate 30 faces the space of the cavity C, and aluminum-based molten metal Y is poured into the cavity C via an injected hole H.

The surface of the plate 30 melts by heat of the molten metal Y, the molten metal Y integrated with the surface of the plate 30 hardens, and, as shown in FIG. 6, a member in which the heat shield film 100 is formed on the surface of a member 300 formed of a molten metal-hardened portion and the plate is manufactured (second step).

With the illustrated forming method, part of the plate 30 of the intermediate product 200 melts by heat of the molten metal, the melted part and the molten metal harden to be integrated with each other, thus forming the aluminum-based member 300. The heat shield film 100 has been already formed on one face of the member 300, so there cannot be an inconvenience that large bubbles are generated in a heat shield film at the time when the heat shield film is directly formed on the wall surface of the member.

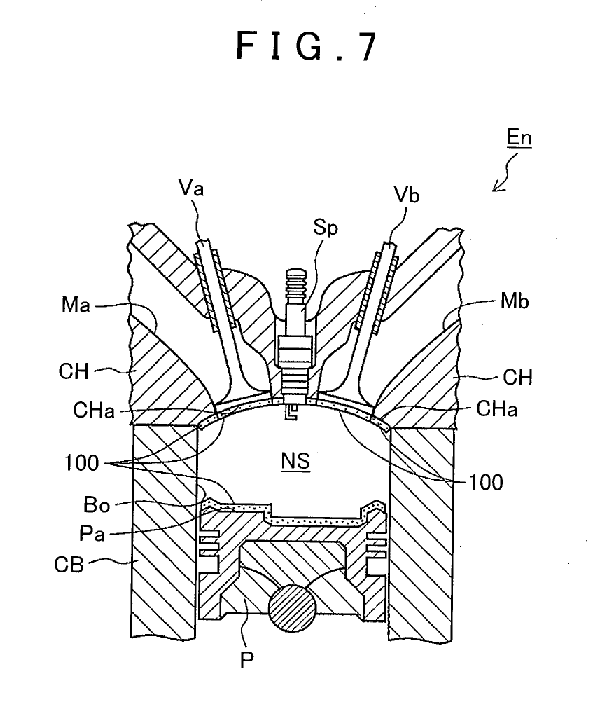

FIG. 7 is a longitudinal cross-sectional view that shows an example in which the heat shield film according to the invention is applied to a wall surface facing a combustion chamber of an internal combustion engine.

The illustrated internal combustion engine En is intended for a gasoline engine, and is roughly formed of a cylinder block CB, a cylinder head CH, an intake valve Va, an exhaust valve Vb, an ignition plug Sp and a piston P. A coolant jacket (not shown) is formed inside the cylinder block CB. The cylinder head CH is arranged on the cylinder block CB. The intake valve Va is arranged at an intake port Ma defined in the cylinder head CH. The exhaust valve Vb is arranged in an exhaust port Mb defined in the cylinder head CH. The ignition plug Sp faces a combustion chamber NS at a center position of a bottom face CHa of the cylinder head CH or substantially the center position. The piston P is provided so as to be movable up and down through a lower opening of the cylinder block CB. Of course, the internal combustion engine according to the invention may be intended for a diesel engine.

The combustion chamber NS is defined by a bore face Bo of the cylinder block CB, the bottom face CHa of the cylinder head CH and a top face Pa of the piston P, which constitute the internal combustion engine En.

In the internal combustion engine En shown in the drawing, the top face Pa of the piston P, the bottom face CHa of the cylinder head CH and the bottom faces of the intake valve Va and exhaust valve Vb each are formed of an aluminum-based member, and the heat shield film 100 according to the invention is formed on the wall surface of each of the aluminum-based members. Of course, for example, the heat shield film 100 may be formed on only any one of them, the heat shield film 100 may be further formed on the bore face Bo in addition, or the two-layer-structure heat shield film 100A may be formed.

The heat shield film 100 includes a large number of the hollow particles 20 inside. Therefore, the heat shield film 100 has a low thermal conductivity, a low thermal capacity and a swing characteristic (which is a characteristic that the temperature of the film follows the gas temperature in the combustion chamber although the film has a heat insulation capability.).

In this way, the illustrated internal combustion engine En includes the heat shield film 100 having a low thermal conductivity and a low thermal capacity at the top face Pa of the piston P, the bottom face CHa of the cylinder head CH, and the like, which are component elements thereof. Therefore, the internal combustion engine En contributes to high-fuel economy and high-efficiency engine performance when the vehicle travels in a steady state.

The inventors created the heat shield film according to Example in the following method, and conducted a test for verifying the correlation between a shearing stress at the interface between a heat shield film and an aluminum-based member and a stress in the heat shield film, together with a heat shield film made of an alumina material and a heat shield film made of an alumite material (these are Comparative Examples). In addition, the thermophysical property of the heat shield film according to Example was measured, the SEN photograph of the interface between the heat shield film according to Example and the aluminum-based member was taken, and EPMA line analysis was carried out.

The two-layer-structure heat shield film shown in FIG. 3 was manufactured as the heat shield film according to Example. In the base layer, a vanadium-based porcelain enamel material (a mixed material of a fit and a glaze) produced by Nippon Frit Co., Ltd. was used as the porcelain enamel material. The composition of the fit is 5 to 10% of V₂O₅, 10 to 20% of TiO₂ and 30 to 40% of SiO₂. The composition of the glaze is 10 to 20% of TiO₂ and 30 to 40% of SiO₂. These fit and glaze were mixed with water at the ratio of 10:9, and the mixed material was sprayed to an aluminum plate (Al—Mg—Si-based alloy having a diameter of 80 mm and a thickness of 2 mm) to a thickness of about 50 μM.

On the other hand, in the upper layer, the same material as that of the base layer was used as the porcelain enamel material, Nanoballoon (the surface of which is modified with a hydrophilic group, which has an average particle diameter of 100 nm) produced by Grandex Co., Ltd. was used as the hollow particles. The hollow particles of 7 percent by mass were mixed with the porcelain enamel material, and the material adjusted in viscosity with water was sprayed to the base layer from above to a thickness of about 50 μm.

After that, the obtained product was dried by vaporizing the water in an atmosphere of 100° C., and then the porcelain enamel material was melted by heating the product in an electric furnace at 630° C. for 10 minutes. Thus, the heat shield film was manufactured.

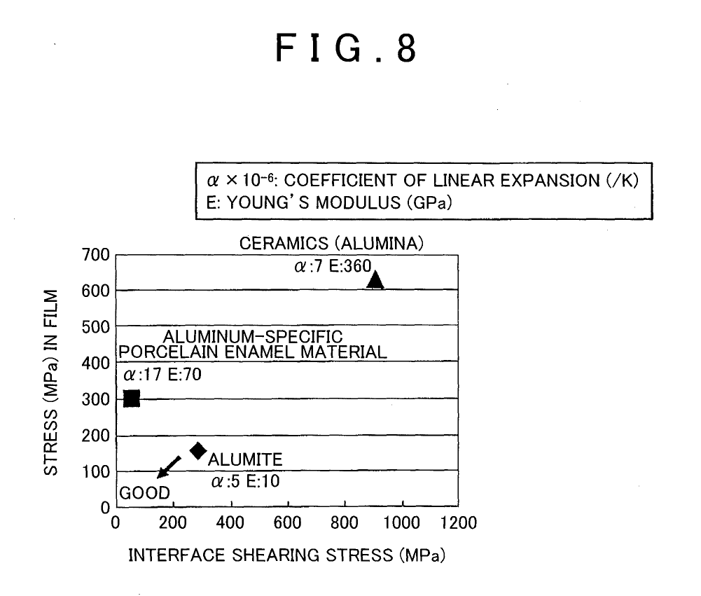

FIG. 8 shows the estimated result of the correlation between a shearing stress at the interface between each of the heat shield films according to Example and Comparative Examples and the aluminum-based member and a stress in the corresponding heat shield film.

It appears from the graph that, in comparison with the heat shield film made of alumina or the heat shield film made of alumite according to Comparative Examples, when the heat shield film made of an aluminum-specific porcelain enamel material according to Example is employed, the shearing stress at the interface between the heat shield film and the member is remarkably reduced and, as a result, the possibility of interfacial peeling decreases as compared to Comparative Examples. The aluminum-specific porcelain enamel material has a higher Young's modulus than alumite, so the stress in the film is larger than that of alumite.

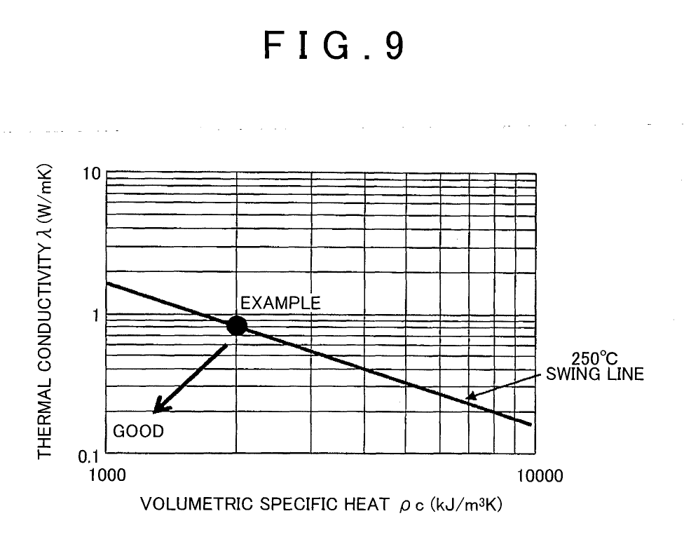

Next, the thermophysical property of the heat shield film according to Example was measured. In a method of measuring the thermophysical property, the density of the heat shield film was measured from the weight and size of the created test piece by subtracting the weight of the aluminum material. In measuring a thermal diffusivity, a laser flash method (LFA457 produced by NETZSCH) was employed as a measuring method, a measurement test piece having a diameter of 10 mm and a thickness of 2 mm (cut out from the above-described created test piece) was used, and the measurement condition was set to 300K (27° C.). For specific heat capacity, a DSC method (DSC404C produced by NETZSCH) was employed as a measuring method, measurement test pieces were obtained such that eight pieces were cut out from the created test piece having a diameter of 6 mm and a thickness of 1 mm, only, the heat shield films were extracted by dissolving aluminum in hydrochloric acid, and the measurement condition was set to 300K (27° C.). A thermal conductivity is calculated by λ=Cp·ρ·α (λ: thermal conductivity, Cp: specific heat capacity, ρ: density, α: thermal diffusivity). A volumetric specific heat is calculated by ρC=ρ·C (ρC: volumetric specific heat, ρ: density, C: specific heat). FIG. 9 shows the measured result of the thermophysical property of the heat shield film according to Example.

It appears from the graph that Example is placed on a 250° C. swing line that is a threshold regarding the swing width according to the invention, and is the heat shield film that satisfies a target swing width.

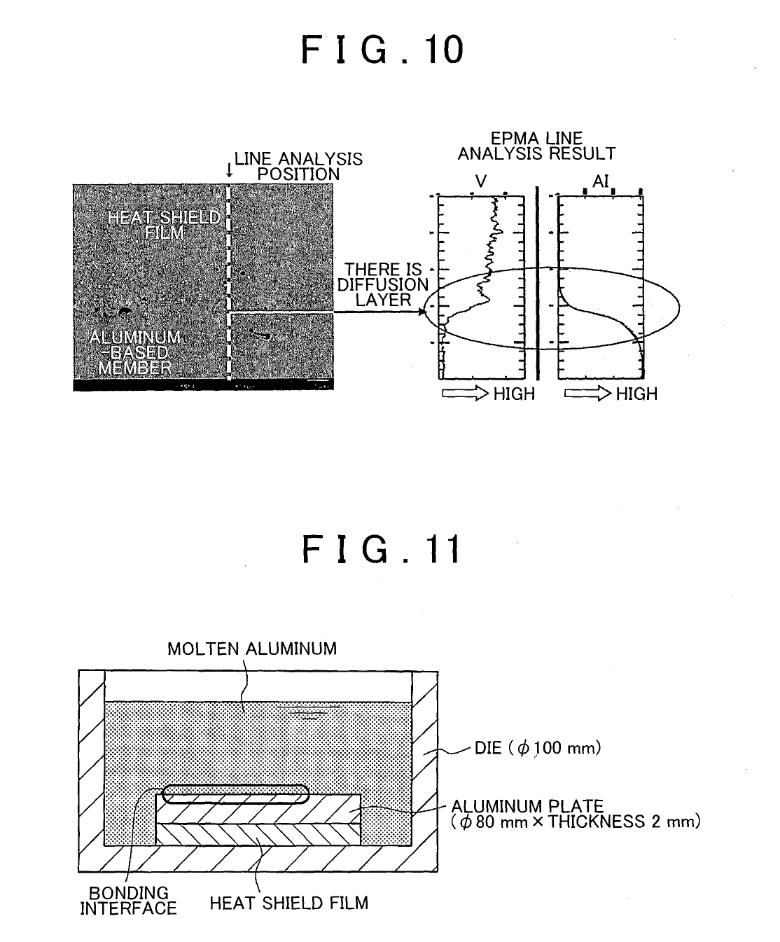

The inventors cut the created test piece according to Example in cross section, took the SEM photograph of the test piece in cross section, and carried out EPMA line analysis. The result is shown in FIG. 10. It has been demonstrated from the drawing that the diffusion bonding layer was formed at the interface between the heat shield film and the aluminum-based member.

The inventors applied a cooling/heating cycle of ordinary temperature to 200° C. to the test piece, took the SEM photograph of the interface, and observed the interface. As a result of observing the end face of the heat shield film to the interface between the heat shield film and the member for a fracture portion, no crack was found.

By irradiating YAG laser (which has an output of 1.4 kW and an irradiation area of φ57 mm) to the heat shield film side of the created test piece in 5 seconds, the following state was repeatedly established. The surface is 500° C., the interface between the heat shield film and the member is 200° C., and a temperature difference within the heat shield film is 300° C.

As a result of observing the surface of the irradiated heat shield film with a microscope, no crack was found on the surface of the heat shield film. Because the surface of the heat shield film is stretched maximally, it may be estimated that no crack was developed in the heat shield film on the basis of the fact that no crack was found on the surface of the heat shield film.

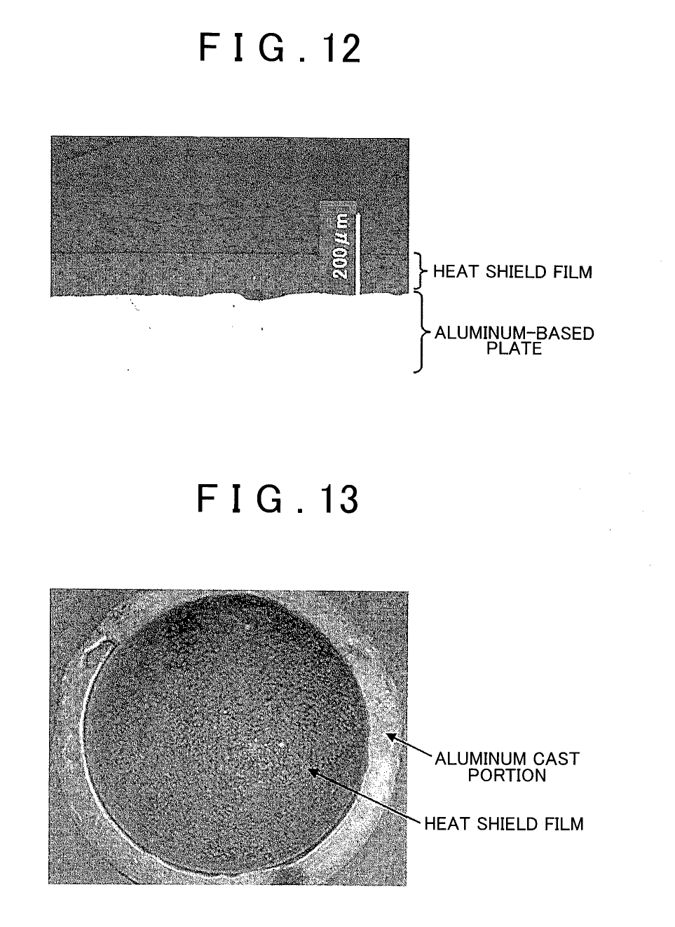

The inventors conducted a test for confirming the effectiveness of the method of forming a heat shield film shown in FIG. 4 to FIG. 6. In this test, a test piece obtained by forming a heat shield film made of a similar material to that of the above-described Example on an aluminum plate of a similar material was accommodated in a die as shown in FIG. 11, aluminum molten metal of 700° C. was filled in the die, the test piece was taken out by separating the die after cooling. It was checked whether there are bubbles in the heat shield film, and it was checked whether there is a crack on the surface of the heat shield film. The results of them are shown in FIG. 12 and FIG. 13.

At the time of checking whether there are bubbles in the film, the created test piece was cut in cross section (portion having a diameter of 80 mm), and it was checked with a microscope whether there are bubbles, with the result that no bubbles were found as shown in FIG. 12.

On the other hand, the surface of the created test piece was magnified with a microscope and it was checked whether there is a crack, with the result that no crack was found as shown in FIG. 13.

The inventors further conducted a test for determining an optimal range of the thickness of the plate that is used in the above-described method of forming a heat shield film according to the invention.

The thickness, of the aluminum plate was variously changed, the created test pieces were cut in cross section (portion having a diameter of 80 mm), and then they were observed with a microscope in magnified view whether there is a gap at the interface between the plate and the cast aluminum hardened portion.

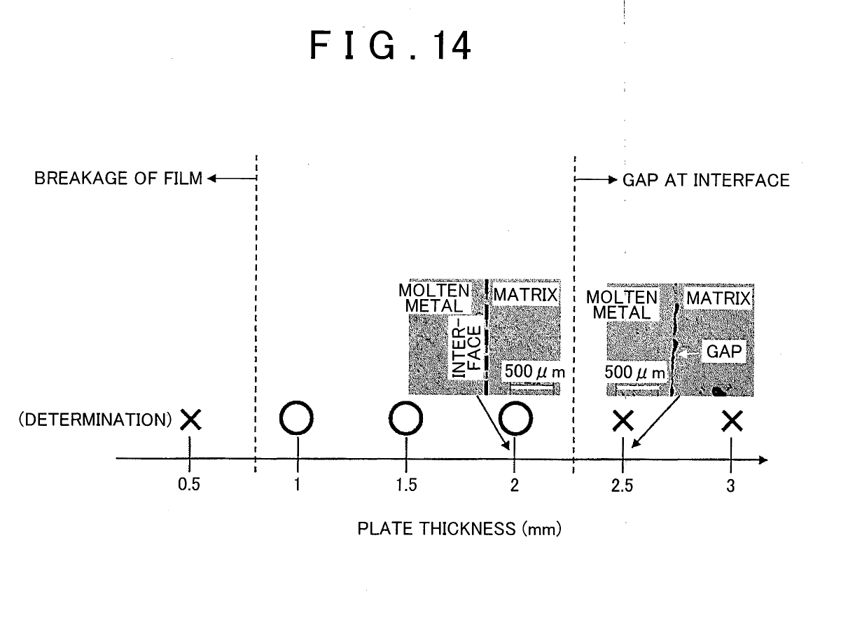

As shown in FIG. 14, the plate caused a film breakage in the case where the plate having a thickness of 0.5 mm was used, whereas a gap was observed at the interface in the case where the plate having a thickness of 2.5 mm or larger was used. On the other hand, in the case where the plate having a thickness of 1 to 2 mm was used, no film breakage occurred or no gap was observed at the interface. As a result, it was found that the range of 1 to 2 mm is optimal for the thickness of the plate that is used at the time of applying the method of forming a heat shield film according to the invention, in which an intermediate product is manufactured in advance.

The inventors conducted a verification test by sampling four types of materials shown in the following Table 1 in order to select a material suitable for the heat shield film made of the porcelain enamel material, formed on the surface of the aluminum-based member.

TABLE 1

| | Coefficient of | | Young's | | | |
|---|---|---|---|---|---|---|
| | Linear | | Modulus | | | |
| | Expansion | | (Higher than or | | | |
| | (×10⁻⁶/K) | Glass | Equal to Glass | | | |
| | (Ordinary | Transition | Transition | Heat-resistant | | |
| | Temperature | Temperature | Temperature) | Temperature | Evaluation | |
| Material | to 200° C.) | (° C.) | (GPa) | (° C.) | Results | Comment |
| Vanadium | 16 | 390 | 45 | 660 | ◯ | |
| Base | | | | | (suitable) | |
| Bismuth | 16 | 380 | 50 | 650 | X | Film is not |
| Base | | | | | (unsuitable) | formed |
| | | | | | | with |
| | | | | | | porous |
| | | | | | | material |
| Phosphate | 16 | 370 | 48 | 600 | X | Film is not |
| Base | | | | | (unsuitable) | formed |
| | | | | | | with |
| | | | | | | porous |
| | | | | | | material |
| Silica | 10 | 500 | 60 | 750 | X | Crack |
| Base | | | | | (unsuitable) | occurred at |
| | | | | | | interface |
| | | | | | | Surface |
| | | | | | | crack |
| | | | | | | occurred |

For a bismuth-based glass material (containing silica-based porous material), a film becomes friable and collapses when a porous material (material: silica) is mixed. This is because the glass material is poorly compatible with the porous material and the glass material and the porous material are not in close adhesion to each other. A prototype was created not only by modifying the surface of the porous material with a hydrophilic group but also a methyl group; however, a similar tendency was observed. The reason why the methyl group was used to modify the surface of the porous material is that a bismuth-based material was not mixed with water but diluted with an organic solvent (terpineol) at the time of application of the material, and considered dispersibility and compatibility with the glass material.

When a porous material (material: silica) is mixed with a phosphorus-based glass material (containing silica-based porous material), the firing temperature increases, and the glass alters. This is because the firing temperature containing the porous material is 600° C. (550° C. in the case of no porous material) and exceeds the heat-resistant temperature 600° C.

In addition, for a silica-based glass material (containing silica-based porous material), an interfacial crack occurred in the above-described cooling/heating test. This is because thermal stress is generated between the glass material and the aluminum. In addition, a surface crack occurred in the above-described YAG laser irradiation test. This is because the glass transition temperature is high, that is, 600° C., and the glass material does not become soft (Young's modulus of 60 GPa).

According to the results of the various verification tests, it was found that the vanadium-based porcelain enamel material was suitable as the material of the heat shield film made of the porcelain enamel material, the material being formed on the surface of the aluminum-based member.

The embodiments of the invention are described in detail with reference to the accompanying drawings; however, a specific configuration is not limited to the embodiments. The invention also encompasses design changes, and the like, without departing from the scope of the invention.

1. A heat shield film comprising:
a matrix layer having a coefficient of linear expansion of 15×10⁻⁶/K to 25×10⁻⁶/K in a temperature range of ordinary temperature to 200° C. and made of a porcelain enamel material; and
hollow particles dispersed in the matrix layer, wherein
the heat shield film is formed on a wall surface of an aluminum-based member, and
the heat shield film is diffusion-bonded to the wall surface.

2. The heat shield film according to claim 1, wherein
a glass transition temperature of the porcelain enamel material is lower than or equal to 400° C., and
a heat-resistant temperature of the porcelain enamel material is higher than or equal to 450° C.

3. The heat shield film according to claim 1, wherein
the porcelain enamel material contains silica,
each of the hollow particles has a silica-based outer shell, and
a surface of each silica-based outer shell is modified with a hydrophilic group.

4. The heat shield film according to claim 1, wherein
the heat shield film has a two-layer structure of an upper layer and a base layer adjacent to the wall surface, and
the base layer contains no hollow particles or contains the hollow particles in an amount smaller than that of the upper layer.

5. A method of forming a heat shield film, comprising:
a first step of manufacturing an intermediate product formed of an aluminum-based plate and the heat shield film on a surface of the plate by applying a mixed material of hollow particles, a glass frit and a glaze onto the surface of the plate, melting the glass frit by heating, and forming the heat shield film, formed of a matrix layer and the hollow particles dispersed in the matrix layer, on the surface of the plate, the matrix layer having a coefficient of linear expansion of 15×10⁻⁶/K to 25×10⁻⁶/K in a temperature range of ordinary temperature to 200° C. and made of a porcelain enamel material; and
a second step of forming the heat shield film on a wall surface of an aluminum-based member formed of a molten metal hardened portion and the plate integrated with the hardened portion by accommodating the intermediate product in a die and casting aluminum-based molten metal on the plate of the intermediate product.

6. The method according to claim 5, wherein
a thickness of a plate ranges from 1 mm to 2 mm.
